(19) United States
(12) Patent Application Publication
(10) Pub. No.: US 2023/0088591 A1
(43) Pub. Date: Mar. 23, 2023

(54) Fault Tolerant System with Minimal Hardware

(71) Applicant: Apple Inc., Cupertino, CA (US)

(72) Inventors: Fernando A. Mujica, Los Altos, CA (US); Joyce Y. Kwong, Sunnyvale, CA (US); Mark P. Colosky, Sunnyvale, CA (US)

(21) Appl. No.: 17/932,177

(22) Filed: Sep. 14, 2022

Related U.S. Application Data
(60) Provisional application No. 63/247,388, filed on Sep. 23, 2021.

(51) Int. Cl. G05B 23/02

(52) U.S. Cl. CPC G05B 23/0221; G05B 2223/02

(57) ABSTRACT

Fault tolerance for an automation controller for a machine is provided. A first portion of phases of the automation controller may be processed with fail operational protection, in which a failure of one of the computers used for the first portion still permits full operational functionality in the machine. The remaining portion of the phases are processed with fail degraded protection, in which a failure of a computer used for the remaining portion permits continued operation but with one or more constraints, as compared to the fail operational portions.

This application claims benefit of priority to U.S. Provisional Patent Application Ser. No. 63/247,388, filed on Sep. 23, 2021. The above application is incorporated herein by reference it its entirety. To the extent that anything in the incorporated material conflicts with the material expressly set forth herein, the expressly-set-forth material controls.

### BACKGROUND

### Technical Field

Embodiments described herein are related to fault tolerant computing, and more particularly to minimizing the hardware needed to provide fault tolerance.

### Description of the Related Art

Some types of computing require fault tolerance to successfully perform a task. For example, in a robotic environment, automated control of the movement of the robot may require fault tolerance to ensure that the robot can be maneuvered without causing injury or damage. Other cases where fault tolerant computing is useful involve environments in which reaching the computer to repair it would be hazardous or impossible (e.g., outer space, at the bottom of the ocean, etc.). Additionally, fault tolerant computing is useful in other environments in which a loss of function could lead to significant harm or damage (e.g., in control of a nuclear power plant or hazardous material processing). Generally, fault tolerance refers to the ability to continue operating correctly in the presence of a failure. Reduced capacity operation can be acceptable in some cases.

Fault tolerance can be achieved in a variety of ways. For example, operating several computers in parallel on the same input data can be used. A triple modular redundant (TMR) scheme, for example, includes three computers operating in parallel. The outputs of the computers can be compared to determine if there is a possible error, and when one output disagrees with the two others, that computer may be considered failed and the other two can continue in operation. However, with the third computer removed from duty, an error can be detected but a correct answer cannot be definitively ascertained. A TMR fault tolerance scheme can detect and remove any error introduced in the compute channel that results in an incorrect output. This can include not only the computational logic but also includes the data/address busses, the memory, etc. Another mechanism is to have two computers that operate in a parallel “fail safe” configuration, and make the parallel systems redundant. For example, a dual lock step, doubly redundant system (“dual-dual”) involves four computers. Each pair of computers runs in parallel (“lock step”). Each pair of computers uses a combination of fault detection mechanisms to identify hardware faults. The fault detection mechanisms can include, e.g., memory error detection and correction, data and address bus error detection, and/or compute logic error detection via redundant lock step calculation and compare. In the event a fault is detected in one “lock step” computer, the other “lock step” computer output can be used.

Fault tolerance permits continued operation in the presence of failure, but is also costly in terms of the hardware needed to perform a task. TMR schemes require three times the amount of computing hardware that a non-fault tolerant system would require. A dual-dual scheme requires four times the amount of computing hardware that a non-fault tolerant system would require. Additionally, since a dual-dual configuration requires that each “lock step” computer detect internal safety-critical hardware failures, fault detection is required for memory, data/address busses, etc.

### SUMMARY

In an embodiment, a reduced-cost fault tolerant system for an automation controller (e.g., for a robotically-controlled mobile machine) is provided. The phases of the automation have been carefully studied to identify the amount of computing needed for each phase, as well as ways to divide the computing to efficiently provide fault tolerance in the system. For example, a portion of the phases may be processed with fail operational protection, in which a failure of one of the computers still permits full operational functionality in the robotically-controlled mobile machine. The remaining portion of the phases may provide fail degraded protection, in which a failure of one of the computers permits continued operation but with one or more constraints as compared to the fail operational portions (e.g., operation at reduced speed, operation with one or more maneuvering capabilities disabled, etc). A more efficient allocation of computational resources may be made, as compared to a conventional TMR or dual-dual systems, while still providing fault tolerance.

### BRIEF DESCRIPTION OF THE DRAWINGS

The following detailed description refers to the accompanying drawings, which are now briefly described.

FIG. 1 is a block diagram of one embodiment of stages of computing for automated robotic operation.

FIG. 2 is a block diagram of one embodiment of hardware to implement the automated robotic operation in a fault-tolerant manner.

FIG. 3 is a table illustrating one embodiment of mapping sensors to computers.

FIG. 4 is a table illustrating one embodiment of computer failures and operation of a machine in response to the failure.

FIG. 5 is a flowchart illustrating a method of fault tolerant operation.

FIG. 6 is a more detailed diagram of one embodiment of computer hardware.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description.

### DETAILED DESCRIPTION OF EMBODIMENTS

In an embodiment, an automation controller for a robotically-controlled mobile machine is described. Generally, a mobile machine may be any machine that is designed to move, and thus has at least one motor that propels the machine in the desired direction of motion. The motor may have any energy source (e.g., electric, gasoline, propane, natural gas, steam, compressed air, etc.). The machine may be designed to perform any form of work. For example, the machine may be a household device such as a vacuum cleaner, a device that operates in a warehouse to move items from one place to another, a device in a manufacturing location that performs a portion or all of the manufacture of an article, a machine to transport persons or cargo, etc. For example, a machine may include a land-based machine of any sort (e.g., car, motorcycle, truck, long haul truck such as a “semi”, mass transportation machines such as a bus, a train, etc., a construction machine such as a backhoe, bulldozer, or the like), water borne machines (e.g., boats, ships, submarines, etc.), flying machines (e.g., planes, helicopters, etc.), etc. Automated control of land-based machine on a roadway will be used in some examples below, but the same discussion may generally apply to any robotically-controlled mobile machine.

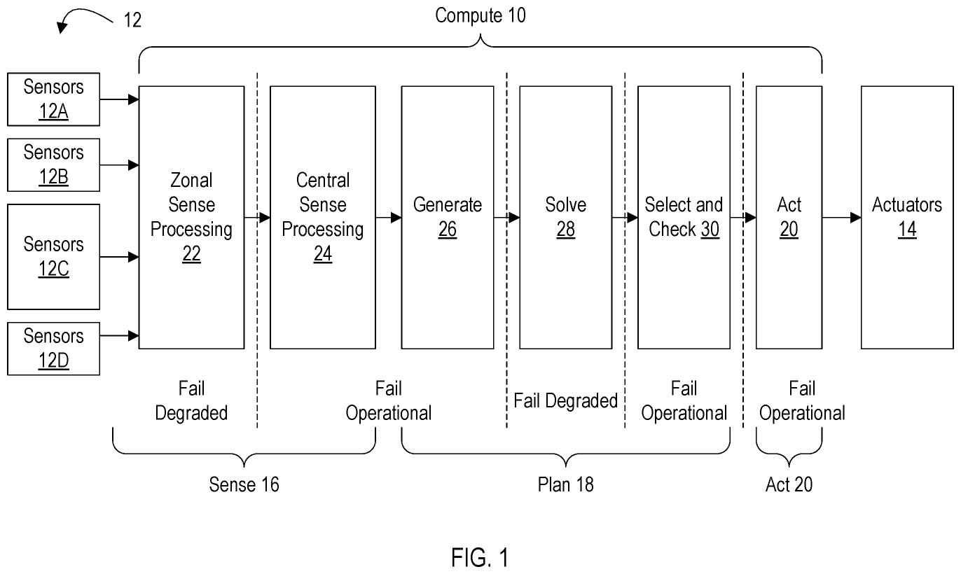

FIG. 1 is a block diagram illustrating one embodiment of the various phases in a compute structure 10 for an automation controller that controls the movement of a robotically-controlled mobile machine. The automation controller may receive sensor input from various sensors 12 on the machine and a mission (e.g., a destination for the machine, action for the machine to take, etc.), and may compute controls for various actuators 14 on the mission to move the machine forward toward completion of its mission. For example, the mission of a land-based machine is to transport its passengers and/or cargo to a specified destination safely and, in the case of passengers, in as much comfort as possible consistent with safety.

The compute structure 10 may generally be divided into a sense phase 16, a plan phase 18, and an act phase 20. In the sense phase 16, data from the sensors 12 is processed to produce an estimate of the surroundings of the machine, also referred to as a world view, world representation, or world estimate. The world view may identify the overall surroundings, including the pathway on which the machine is traveling, as well as the positions of markers, signs, paths, and objects. Objects may include non-moving objects that may be nearby (e.g., trees or other plant life, buildings, trash cans, statues, light poles, etc.). The non-moving objects may also be referred to as “static objects.” Other objects in the world view may be in motion, or may be “dynamic objects.” Dynamic objects may include other machines, pedestrians, bicycles, animals, etc. Dynamic objects may be represented in the world view with a position and a motion estimate. The plan phase 18 may receive the world view and the mission, and may determine a trajectory for the machine to follow. The trajectory may be the path that the machine is to follow for a period of time, advancing the machine toward the end of the mission. That is, the trajectory may not be the path completely to the end of the mission, but rather may be a segment of the overall mission. For example, in an embodiment, the trajectory may describe the motion for the next N seconds, where N is a positive value. For example, N may in the range of 5-15 seconds, and more particularly may be around 8 seconds. The act phase 20 may receive the trajectory, and may generate the actuator controls, as mentioned above.

If one were to make all of the compute structure 10 as TMR or dual-dual for fault tolerance, the computational capacity needed would 3× (for TMR) or 4× (for dual-dual) the amount of computational capacity needed to perform the computations without fault tolerance. The cost of such a computer structure 10 may be prohibitive. However, through careful analysis of the data and computations on the data, a more minimal hardware cost may be implemented while still providing system level fault tolerance. The compute structure 10 may be implemented on a plurality of computers, as will be discussed in more detail below. For example, at least three computers may be implemented, although there may be more computers in other embodiments. However, where a fault in a given phase, or subphase, may lead to an acceptable degraded operation performance level, TMR can be avoided. For example, a fault in a given phase, or subphase, that cannot lead to a safety-critical failure or outcome may be an acceptable degraded operation performance level. In these phases, or subphases, the available compute resources can be used in a non-TMR configuration allowing for effectively 3× the compute capacity as compared to a TMR configuration.

In one embodiment, the sense phase 16 may be divided into a zonal sense processing subphase 22 and central sense processing subphase 24. The plan phase 18 may be divided into a generate subphase 26, a solve subphase 28, and a select and check subphase 30. The act phase 20 may not be divided into subphases in this embodiment. The zonal sense processing 22 may take advantage of the fact that at least some of the sensors 16 have overlapping fields of view, as discussed below. That is, if two sensors have an overlapping field of view, data from one of the sensors is processed by one computer and data from the other sensor is processed by a different computer. If one of the two computers fail, there is still some visibility to the lost field of view due to the overlapping field of view from the other sensor on the non-failing computer. Thus, the zonal sense processing phase need not be TMR or dual-dual, and instead each sensor may have its data processed by one of the computers. The zonal sense processing subphase 22 may have fail degraded operation because the loss of one computer may be tolerated by restricting the operation of the machine in some fashion as compared to when all computers are operating. In addition to the loss of a computer, fail degraded operation may be used if a computer produces incorrect results (e.g., due to a failure in the compute path or other malfunction). Incorrect results may be detected via techniques such as rationality checks, consistency checks, cross-modality checks, secondary sensor checks, etc. The restriction may have to do with which sensors are no longer being processed (e.g., if sensors viewing the front left of the machine are not being processed, then left turns may be prohibited, or unprotected left turns may be prohibited). Other restrictions may be generic (e.g., the speed of the machine may be reduced).

The zonal sense processing subphase 22 may identify the objects in the field of view of each of the sensors, and may provide the object data to the central sense processing subphase 24. The central sense processing subphase 24 may resolve the object data from different sensors that have overlapping fields of view. For example, if there is an object in the object data from one sensor but not in the object data from another sensor that overlaps, or if the object is identified differently by different sensors, the central sense processing subphase 24 may determine how to resolve the difference.

The central sense processing subphase 24 may also assemble the object data into the world view. The central sense processing subphase 24 may have fail operational protection (e.g., TMR). The loss of a computer/malfunction of a computer may still provide two computers producing a world view, and thus there is still redundancy in the result after the failure of one computer.

The generate subphase 26 may receive the world view and the mission, and may generate various possibilities, or options, for the trajectory. The possibilities may be in the form of a hypothesis: if the machine adopts a certain trajectory (e.g., stay on the current path, change paths to the left or right, make a right turn or a left turn, etc.) and the dynamic objects in the world view continue with their motions as indicated in the motion estimate, or if they vary their motion in a particular way, what will the result be? The generate subphase 26 may also have fail operational protection. In an embodiment, the zonal processing subphase 22 may perform the bulk of the sense processing and thus the cost of having the central sense processing subphase 24 with fail operational protection may be minimized. That is, the computing bandwidth needed to perform the central sense processing subphase 24 may be low compared to the other sense 16 subphases. Similarly, the generate subphase 26 may have a relatively low computational bandwidth requirement.

The solve subphase 28 may receive the generated options from the generate subphase 26, and may attempt to generate a trajectory based on the options. Some options may not solve properly (e.g., a given option will likely cause a collision, or a given option is not considered safe enough). For other options, the solve subphase 28 may generate a trajectory. The solve subphase 28 may require significantly more computing bandwidth than other plan 18 subphases. If the solve subphase 28 is divided across the computers, providing no redundancy, then the failure of one computer would results in a loss of a portion of the possible trajectories, but in most cases an acceptable trajectory may be generated. If it is desirable for a particular option to always be available (e.g., stay on path and maintain speed), the option may be included in the subset of generate results processed by each computer. Thus, fail degraded operation may be achieved for the solve subphase 28 and each computer need only have enough computational bandwidth to solve 1/Nth of the options, where N is the number of computers (e.g., 3 if there are three computers). If one or more particular options are included in each subset, each computer may have enough computation bandwidth to solve 1/Nth of the options+M options, where M is an integer equal to a number of the one or more particular options included in each subset.

The select and check subphase 30 may apply a cost function to the various trajectories (e.g., safety being weighted most important, passenger comfort weighted with a less importance, time to complete mission weighted with an even lesser importance or optionally higher importance than comfort if there is a time deadline to complete the mission, etc.). The minimal cost trajectory may be judged to be the “best” trajectory and may be selected. Finally, the select and check subphase 30 may check the selected trajectory for an unacceptable result (e.g., a collision) and may reject the selected trajectory and provide a default trajectory (e.g., stop safely) if the selected trajectory is not acceptable. For example, the selected trajectory may be unacceptable if it does not have at least a specified minimum probability of avoiding a collision. The select and check subphase 30 may have a relatively low computational bandwidth and thus may be provided with fail operational protection.

The act phase 20 may process the trajectory and control the actuators 14 to follow the trajectory. The act phase 20 may be implemented, in an embodiment, on a different set of computers than the sense and plan phases 16 and 18. In an embodiment, the act phase 20 may have dual-dual protection and thus may be fail operational.

In another embodiment, the sense and/or plan phases 16 and 18 may be implemented with fail safe protection. For example, the central sense processing subphase 24, the generate subphase 26, and/or the select and check subphase 30 may have fail safe protection such as dual modular redundant (DMR) protection. Such protection may be acceptable, for example, if the machine has a human monitoring operation of the automation system and who is able to take over operation if there is a fault. In another example, if the act phase 20 is able to fully execute the fault response for an error in the sense and/or plan phases 16 and 18 (e.g., by following a last known trajectory to a stop), fail safe operation of the sense and/or plan phases 16 and 18 may be provided. Since the zonal sense subphase 22 and solve subphase 28 are not implemented with DMR protection, a reduction in required compute capacity may still be achieved relative to a full DMR implementation of sense and plan phases 16 and 18.

The sensors 12 may include any set of devices that are configured to sense the area around the machine, objects in the area, etc. The sensors may be any combination of any type of sensors. The operation of the compute structure 10 may generally be agnostic to sensor type. For example, the sensors 12 may include one or more sensors 12A, one or more sensors 12B, one or more sensors 12C, and one or more sensors 12D. The sensors 12 may be arrayed in various locations around the machine to allow detection of the environment in which the machine is operating. The sensors 12 may have overlapping fields of view so that the output of one sensor may be compared to that of another sensor that overlaps the field, to further refine the estimate of the area that is overlapped by the sensors 12, and also so that the failure of one sensor 12 may not result in a “blind spot” of significant size until more than one sensor fails. Thus, the overlapping fields of view may provide a measure of fault tolerance. Any combination of sensors may be used (e.g., camera sensors, light detection and ranging (lidar) sensors, short range sensors, radio detection and ranging (radar) sensors, sonic or ultrasonic sensors, etc.

Camera sensors may include any type of sensor that captures a visible light image of the field of view. The camera sensor output may be a set of pixels which indicate the color/intensity of light at that position within the frame (or picture) captured by the camera sensor. A visible light camera sensor may be a passive sensor that captures visible light (electromagnetic waves in the visible light spectrum). Other types of cameras may capture other wavelengths of light (e.g., infrared cameras). The camera sensor may be a passive sensor, if the sensed wavelengths is/are prevalent in the environment and reflected by objects in the environment (e.g., visible light) or are actively emitted by the sensed object. The camera sensor may also be an active sensor if the camera sensor actively emits the light and observes any reflected light (e.g., infrared light).

Lidar sensors may include an active sensor that emits electromagnetic waves having wavelengths in the light spectrum (light waves) and observing the reflections of the emitted waves. For example, the lidar sensors may emit infrared wave pulses from lasers and detect reflected pulses. Other lidar sensors may use lasers that emit other wavelengths of light such as ultraviolet, visible light, near infrared, etc. The lidar sensor may be used to detect range, motion, etc.

Radar sensors may include an active sensor that emits electromagnetic waves in the radio spectrum (radio waves) and/or microwave spectrum, and observes the reflection of the radio waves/microwaves to detect objects that reflect radio waves.

Radar may be used to detect the range of an object (e.g., a position and distance), motion of the object, etc.

Short range sensors may include any sensors that are configured to detect the environment of the machine that is closer to the machine than the other sensors detect.

For example, the short range sensors may comprise radars tuned to a shorter range than the other radar sensors.

The number and placement of the various sensors 12 shown in FIG. 1 may vary from embodiment to embodiment. There also may be other types of sensors, such as sonic or ultrasonic sensors, in other embodiments.

Any set of actuators 16 may be provided, in an embodiment. For example, the actuators 16 may include steering actuators that control the steering of the machine, propulsion actuators that control the motor of the machine or other power source of the machine to move the machine forward or in reverse, braking actuators that apply the brakes to slow the machine, and optionally active suspension actuators that control the suspension of the machine.

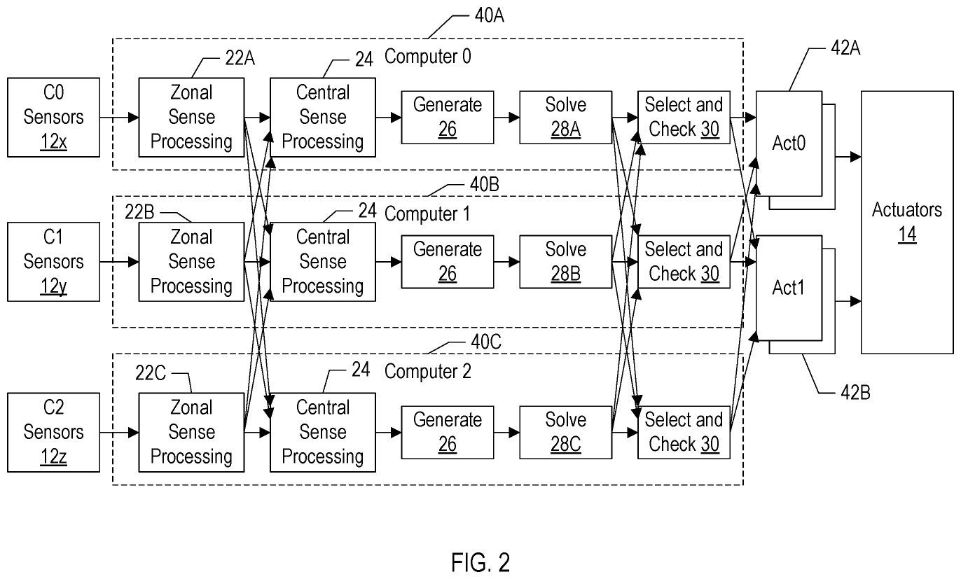

Turning now to FIG. 2, a block diagram of one embodiment of an automation controller comprising a plurality of computers 40A-40C and a plurality of act computers 42A-42B is shown, coupled to the sensors 12 and the actuators 14. The act computers 42A-42B are coupled to computers 40A-40C as well. More particularly, each of the computers 40A-40B are coupled to different subsets of the sensors 12 (e.g., sensors 12x are coupled to the computer 40A; sensors 12y are coupled to the computer 40B, and sensors 12z are coupled to the computer 40C). The sensors 12x-12z may comprise the sensors 12A-12D shown in FIG. 1, with different instances of the sensors 12A-12D spread among the subsets 12x-12z. More particularly, instances of the sensors 12A-12D that have overlapping fields of view may be included in different subsets 12x-12z. For example, an instance of the camera sensors may have a field of view covering the right front of the machine, and an instance of the radar sensors may have a field of view covering the right front of the machine as well, although the fields of view need not be completely co-extensive. The instance of the camera sensors may be included in one of the subsets 12x-12z (e.g., sensors 12z), and the instance of the radar sensors may be included in a different one of the subsets 12x-12z (e.g., sensors 12y). Thus, if the computer 40C fails, the input from the instance of the camera sensors may not be processed but the input from the instance of the radar sensors may still be processed. At least some visibility to the front right of the machine may thus be maintained. While three computers 40A-40C are shown, other embodiments may include more computers, as desired.

With the sensors 12x-12z divided as discussed above, each computer 40A-40C may perform zonal sense processing on the sensor data from the respective sensors 12x-12z (reference numerals 22A-22C in FIG. 2). That is, over the computers 40A-40C, the zonal sense processing 22 in FIG. 1 may be completed. If one of the computers 40A-40C fails, the zonal sense processing 22 may continue on the remaining computers 40A-40C in fail degraded mode, with at least some sensor coverage on all sides of the machine but not the complete coverage available when all computers 40A-40C are online. For example, if one computer 40A-40C fails, approximately one third of the total sensor data, distributed around the fields of view surrounding the machine, may be lost.

The computers 40A-40C may communicate the zonal processing results to each other, so that each computer 40A-40C has all of the zonal processing results to perform central processing 24. Accordingly, the computers 40A-40C may provide TMR (fail operational) protection for the central processing 24. That is, each of the computers 40A-40C may produce a central sense processing result (a world view, or world estimate) that may be compared to the result from other computers 40A-40C to detect error and, in the case of mismatch, to vote on the result with the computers 40A-40C that match winning the vote. Also, if one computer 40A-40C consistently mismatches, that may be an indication of failure and the computer may be taken offline and regarded as failed.

Each computer 40A-40C may process the world view and the mission of the machine in the generate subphase 26, which is also provided with TMR (fail operational) protection in this example. The generate results may be compared among the computers 40A-40C in a similar fashion to the central sense processing results as discussed above.

The generated options may be provided to the solve subphase 28A-28C in the respective computers 40A-40C. Across the computers 40A-40C, the solve subphase 28 shown in FIG. 1 may be completed. Each solve subphase 28A-28C may receive the generate subphase 26 results, and may solve a different portion of the overall generate subphase 26 results. For example, the solve subphase 28A may solve the first third of the generate subphase 26 results; the solve subphase 28B may solve the middle third of the generate subphase 26 results; and the solve subphase 28C may solve the last third of the subphase 26 generate results. Any other division of the generate subphase 26 results may be made in other embodiments. If one of the computers 40A-40C fails, then solutions for two-thirds of generate subphase 26 results may be provided (fail degraded protection). As mentioned previously, if a particular generated option is one that is desirable to always have available (e.g., stay on the current path and maintain speed), that option may be included in each third of the results so that each solve subphase 28A-28C may solve on that option.

The select and check subphase 30 may be performed in parallel on the computers 40A-40C, and the results compared as discussed above, providing TMR (fail operational) protection. The result trajectory is provided to the act computers 42A-42D, which provide dual-dual (fail operational) protection for the act phase, controlling the actuators 14.

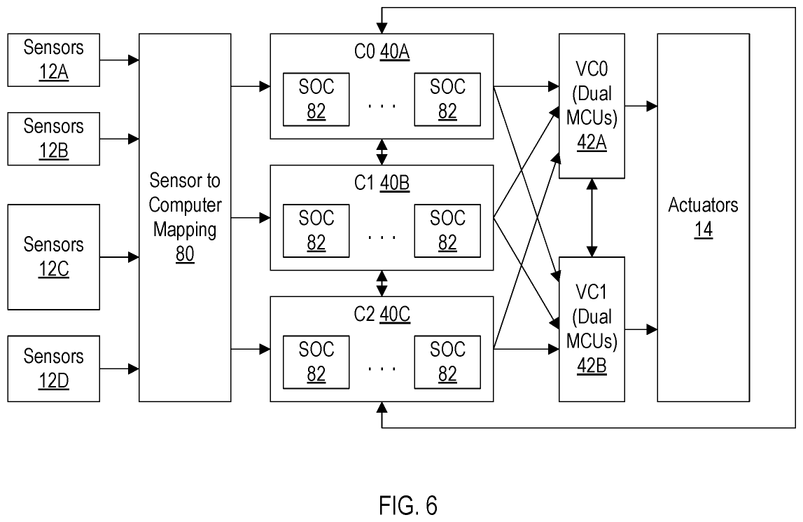

The computers 40A-40C may have the same computational bandwidth and performance parameters (e.g., the computers 40A-40C may be instances of the same computer system design). Each computer 40A-40C may include processor hardware, memory, and various peripherals forming a computer system. An example is shown in FIG. 6 and discussed in more detail below.

By dividing some of the more compute-intensive phases/subphases among the computers 40A-40C with fail-degraded protection, less hardware may be required in the computers 40A-40C than might otherwise be required if TMR (fail operational) protection was provided for each phase/subphase. For example, the computational bandwidth/performance of a given computer 40A-40C may be the minimum required to provide one third of the zonal sense processing subphase 22 and the solve subphase 28 and all of the central sense processing subphase 24, the generate subphase 26, and the select and check subphase 30. In an embodiment, for example, the inventor has discovered that the computational bandwidth of the solve phase 28 and the zonal sense processing phase 22 is greater than other phases/subphases and can be accomplished with fail-degraded protection by careful selection of sensor data processes by each computer. Thus, the maximum computational bandwidth required of the computers 40A-40C may be reduced, reducing the cost for the computers 40A-40C.

In accordance with this disclosure, an automation controller may comprise a first plurality of computers configured to process sensor data from a plurality of sensors on a robotically-controlled mobile machine to generate an output trajectory to be followed by the robotically-controlled mobile machine and a second plurality of computers coupled to the first plurality of computers and configured to control a plurality of actuators in the robotically-controlled mobile machine to cause the robotically-controlled mobile machine to follow the output trajectory. The first plurality of computers may be configured to provide fail degraded protection for a portion of the processing and fail operational protection for a remainder of the processing. The fail degraded protection allows the robotically-controlled mobile machine to operate after a failure of one of the first plurality of computers with one or more constraints. The one or more constraints are not applied to robotically-controlled mobile machine operation after a failure of one of the first plurality of computers with fail operational protection. The second plurality of computers may implement a dual lockstep, doubly redundant mechanism to provide fail operational protection. In an embodiment, respective computers of the first plurality of computers may be configured to process sensor data from non-overlapping subsets of the plurality of sensors. The first plurality of computers may be configured to provide fail degraded protection for processing of the sensor data from the subsets. In an embodiment, the first plurality of computers may be configured to further process a result of the processing of the non-overlapping subsets, wherein the further processing is performed over the data from the result as a whole. The first plurality of computers may be configured to provide fail operational protection for the further processing. In an embodiment, the first plurality of computers may be configured to process data describing a plurality of objects surrounding the robotically-controlled mobile machine to generate a plurality of potential actions by the robotically-controlled mobile machine and the plurality of objects. The first plurality of computers may be configured to provide fail operational protection to generate the plurality of potential actions. In an embodiment, respective computers of the first plurality of computers may be configured to compute a plurality of trajectories from non-overlapping subsets of the plurality of potential actions, wherein the first plurality of computers may be configured to provide fail degraded operation protection to compute the plurality of trajectories. In an embodiment, the first plurality of computers may be configured to evaluate a plurality of trajectories against a predetermined cost function to select the output trajectory. The first plurality of computers may be configured to check the output trajectory to ensure that the output trajectory has at least a specified minimum probability of avoiding a collision. The first plurality of computers may be configured to provide fail operational protection to evaluate the plurality of trajectories to select the output trajectory and to ensure that the output trajectory has at least the specified minimum probability of avoiding a collision. In an embodiment, the first plurality of computers may be configured to detect a failure of a first one of the first plurality of computers and to continue operation of the robotically-controlled mobile machine in fail degraded mode based on the failure. In an embodiment, the first plurality of computers may be configured to detect a failure of at least two of the first plurality of computers and to bring the robotically-controlled mobile machine to a stop based on the failure. In an embodiment, the one or more constraints include operating the robotically-controlled mobile machine at a reduced speed compared to fail operational mode. In an embodiment, the one or more constraints include operating the robotically-controlled mobile machine while preventing one or more actions that the robotically-controlled mobile machine is permitted to perform when the first plurality of computers are operating. In an embodiment, a machine may comprise a plurality of sensors and an automation controller coupled to the plurality of sensors, wherein the automation controller comprises the first plurality of computers and the second plurality of computers.

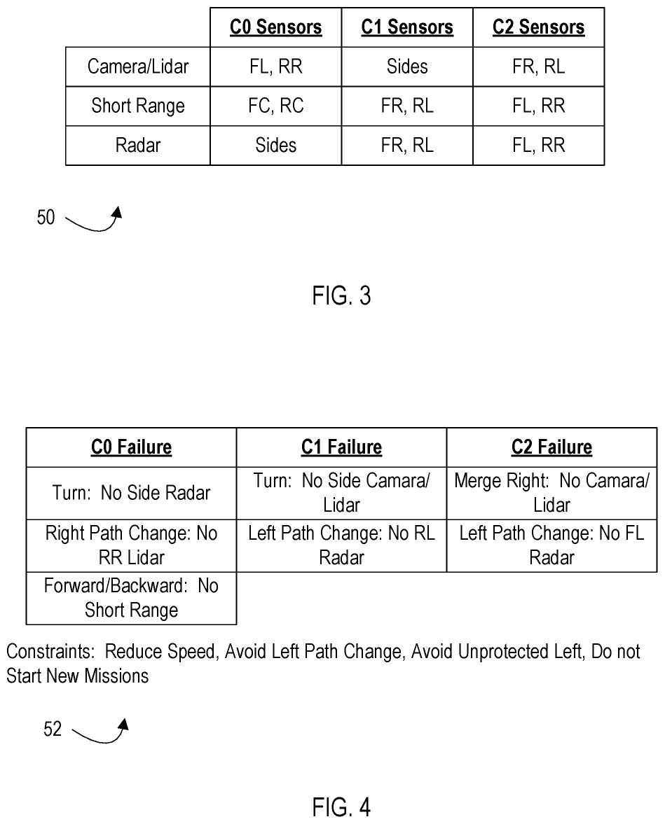

FIG. 3 is a table 50 illustrating one embodiment of mapping sensors to computers for a land-based machine embodiment. In this embodiment, there may be separate camera and lidar sensors with the fields of view with respect to the machine:

front left (“FL”), front right (“FR”), rear left (“RL”), rear right (“RR”) and left and right sides. Thus, there are at least 6 pairs of camera/lidar sensors in this example. Similarly, there may be 6 separate short range sensors with the following fields of view: FL, FR, RL, RR, front center (e.g., directly in front of the machine, “FC”), and rear center (e.g., directly behind the machine, “RC”) in this embodiment. There may be 6 separate radar sensors as well, FR, FL, RR, RL, and left and right sides.

As shown in the table 50, the RL and RR camera/lidar sensors, the FC and RC short range sensors, and the side radar sensors may be grouped as the CO subset of sensors 12x and may be processed by the computer 40A. The right and left side camera/lidar sensors, the FR and RL short range sensors, and the FR and RL radar sensors may be group as the Cl subset of sensors 12y and may be processed by the computer 40B. The FR and RL camera/lidar sensors, the FL and RR short range sensors, and the FL and RR radar sensors may be grouped as the C2 subset of sensors and may be processed by the computer 40C.

With the arrangement as shown in FIG. 3, the loss of any one computer does not leave an area around the machine completely void of sensor coverage. For example, if the computer 40A fails, the FL and RR camera/lidar sensors will not be available but the RL and RR short range sensors and radar are still being processed by the computer 40C. The FC and RC short range sensors will be available, but those are overlapped by the FL, FR, RR, and RL sensors still being processed by the other computers 40B and 40C. The side radar sensors will not be available but the camara/lidar sensors on the sides are still being processed by the computer 40B.

FIG. 4 is a table 52 illustrating one embodiment of computer failures and operation of a machine in response to the failure, based on the subsets of sensors processed by each computer as shown in FIG. 3. If there is a failure of the computer 40A (CO failure column in table 52), turns are impacted by the loss of side radar, which may detect rapidly approaching machines. For a right path (e.g., lane) change, the impact of the failure of the computer 40A may be the lack of RR lidar, which may detect a cyclist to the right of the machine in the land-based machine embodiment, for example. For ensuring that forward and backward motion is clear, the lack of short range sensors may leave a small object close to the machine undetected. If there is a failure of the computer 40B (Cl failure column in table 52), impacts may include a lack of camera/lidar coverage on the sides, which may make the detection of cyclists challenging in the land-based embodiments. Additionally, for a left path (e.g., lane) change, the lack of RL radar may make the left path (e.g., lane) change more dangerous. For a failure of the computer 40C, a right path (e.g., lane) merge may be impacted by the lack of FR camera/lidar and a left path (e.g., lane) change may be affected by the lack of FL radar.

One constraint that may be specific to the loss of a given computer may be to avoid, to the extent possible, the impacted maneuvers. More generally, constraints that may be applied for any computer loss may include reduced speed, avoiding left path (e.g., lane) changes, avoiding unprotected left turns (which are more challenging than protected left turns), and inhibiting the start of new missions (e.g., once the machine reaches its destination, it may stop and not start a new trip until the failure is corrected. The constraints may factor into the cost function used by the select and check sub phase 30, for example. Turning may not be completely avoidable, for example, but the selection of trajectories may attempt to limit the number of turns executed.

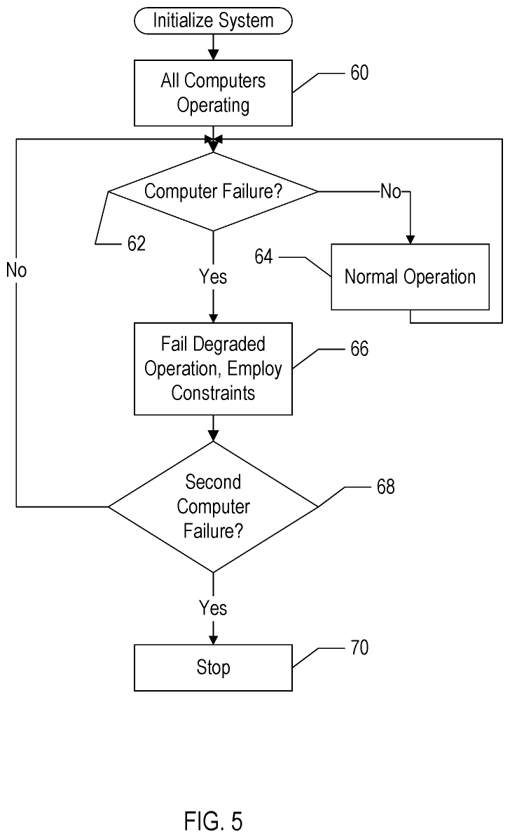

FIG. 5 is a flowchart illustrating a method of fault tolerant operation. Once the system is initialized, all computers 40A-40C may be in operation (block 60). If no computers 40A-40C are detected as failing (decision block 62, “no” leg), the machine may continue in normal operation (block 64). That is, the machine may operate without any constraints that would be applied in fail degraded operation. If one of the computers 40A-40C is detected as failing, the machine may continue operating also (decision block 62, “yes” leg). Once a computer 40A-40C has failed, the machine may continue in fail degraded operation (block 66). Constraints related to fail degraded operation may be applied. If a second computer 40A-40C fails while the initial failure is active (decision block 68, “yes” leg), safe operation may no longer be guaranteed and the automation controller may bring the machine to a safe stop as soon as possible (block 70). If a second computer 40A-40C has not failed (decision block 68, “no” leg), the automation controller may continue operating (normally or fail degraded, depending on if the initial computer 40A-40C remains in a state of failure).

When a failure of a computer 40A-40C is detected, the automation controller may, in some embodiments, attempt to remedy the failure. The automation controller may reinitialize the computer (or “reboot” the computer) and attempt to bring the computer online, for example.

In fail degraded operation, the phases/subphases for determining a trajectory that have fail degraded protection are operated in a degraded mode, while those phases/subphases that have fail operational protection continued with full operation. Thus, in an embodiment, a method may comprise: zonally processing sensor data from a plurality of sensors in respective computers of a first plurality of computers, providing fail degraded protection during the zonally processing; centrally processing, by the first plurality of computers, data resulting from the zonally processing, providing fail operational protection during the centrally processing; generating, by the first plurality of computers, a plurality of potential actions for a machine based on a plurality of objects surrounding the machine identified by the zonally processing and centrally processing; generating a plurality of potential trajectories by the first plurality of computers based on the plurality of potential actions, providing fail degraded protection during the generation of the plurality of potential trajectories; and evaluating, by the first plurality of computers, the plurality of potential trajectories to select on output trajectory, providing fail operational protection during the evaluating. In an embodiment, the method further comprises controlling a plurality of actuators in the machine to follow the output trajectory by a second plurality of computers, wherein the second plurality of computers provide dual lock step, double redundant fail operational protection.

FIG. 6 is a more detailed diagram of one embodiment of computer hardware that may implement the automation controller. The sensors 12A-12D may be coupled to a sensor to computer mapping circuit 80, which may be coupled to the computers 40A-40C. More particularly, the sensor to computer mapping circuit 80 may map subsets of the sensors to respective computers of the plurality of computers 40A-40C. The subsets may be non-overlapping. In an embodiment, the mapping may be fixed in hardware and the sensor to computer mapping circuit 80 may comprise hardwired connections from the sensors to the respective computers 40A-40C. In another embodiment, the mapping may be partially or fully programmable, and the sensor to computer mapping circuit 80 may comprise programmable registers and routing circuits (e.g., multiplexors and select circuitry) controlled by the registers to connect the sensors 12A-12D to the respective computers 40A-40C.

Each computer 40A-40C may comprise a plurality of systems on a chip (SOCs) 82. Each SOC 82 may comprise at least one or more processors and one or more memory controllers integrated on a single semiconductor substrate. Various peripheral components and/or peripheral interface controllers such as peripheral component interconnect (PCI, PCIe, etc.) or universal serial bus (USB) interface controllers to connect to off-SOC peripheral components. Each SOC 82 may be coupled to one or more memories (e.g., static random access memory (SRAM), dynamic RAM (DRAM) such as synchronous DRAM (SDRAM), double data rate SDRAM (DDR, DDR2, DDR3, DDR4, DDR5, etc. including mobile versions such as LP3, LP4, LP5, etc.), etc.). The memories may be on a memory module coupled to the SOC 82, or may be packaged with the SOC 82 in a chip-on-chip (COC), package-on-package (POP), or multi-chip module (MCM) configuration.

The number of SOCs 82 included in a given computer 40A-40C may be based on the computational requirements of the various phases/subphases described above, with the fail operational or fail degraded protection for each phase or subphase as described above. That is, the number of SOCs 82 may be sufficient to provide the computation requirements of a given computer 40A-40C in the system for each of the above phases/subphases. While the present embodiments use SOCs 82, other embodiments of the computers 40A-40C may employ a discrete component implementation in which the processors, memory controllers, etc. are not integrated onto a single semiconductor substrate.

The computers 40A-40C may also be coupled to each other, as shown in FIG. 6. The coupling may allow for the computers 40A-40C to compare results, when redundant processing is employed (e.g., fail operational protection). The comparisons may permit the computers 40A-40C to detect failures. For example, if two computers 40A-40C generate matching results from redundant processing and the third computer 40A-40C generates a non-matching result, it is likely that the third computer 40A-40C has failed and should be ignored. Once a failure is detected the two remaining computers 40A-40C may continue in fail degraded operation for some phases/subphases and fail operational operation for other phases/subphases. The fail operational phases/subphases may continue to compare results and, if a mismatch occurs, a second failure may be detected. It is not known which computer 40A-40C is the second failure, but the failure is known and appropriate action may be taken when the second failure is detected.

The computers 40A-40C may be individually coupled to each of the computers 42A-42B to provide input trajectories. The computers 42A-42B may each be dual microcontroller units (MCUs), thus providing dual-dual protection for the act phase 20. The MCUs may be “hardened” MCUs that are designed for potentially harsh conditions that may exist in land-based machines. The computers 42A-42B are coupled in parallel to the actuators 14 to provide controls, and may be coupled to each other for result comparison purposes to detect failure. The dual MCUs in each computer 42A-42B may execute in lockstep and compare results as well, locally, to detect failure.

The comparison of results may be performed in any fashion between (and within) the computers 42A-42B. In some embodiments, the computers 40A-40C may also compare results, although in other embodiments results from the computers 40A-40C need not be compared. For example, the computers 40A-40C may compute a hash function over each result and may exchange the hashes, or the comparison of hashes or the results themselves may be performed in the computers 42A-42B. Similarly, the computers 42A-42B may compute a hash function (which need not be the same as the hash function used by the computers 40A-40C, but may be the same if desired) and may exchange hashes.

The present disclosure includes references to “an” “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages.

For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of ... w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure.

Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. An automation controller comprising:
a first plurality of computers configured to process sensor data from a plurality of sensors on a robotically-controlled mobile machine to generate an output trajectory to be followed by the robotically-controlled mobile machine, wherein the first plurality of computers are configured to provide fail degraded protection for a portion of the processing and fail operational protection for remainder of the processing, wherein the fail degraded protection allows the robotically-controlled mobile machine to operate after a failure of one of the first plurality of computers with one or more constraints, wherein the fail operational protection allows the robotically-controlled mobile machine to continue to operate after a failure without application of the one or more constraints; and
a second plurality of computers coupled to the first plurality of computers and configured to control a plurality of actuators in the robotically-controlled mobile machine to cause the robotically-controlled mobile machine to follow the output trajectory, wherein the second plurality of computers implement a dual lockstep, doubly redundant mechanism to provide fail operational protection.

2. The automation controller as recited in claim 1, wherein respective computers of the first plurality of computers are configured to process sensor data from non-overlapping subsets of the plurality of sensors, and wherein the first plurality of computers are configured to provide fail degraded protection for processing of the sensor data from the subsets.

3. The automation controller as recited in claim 2 wherein the first plurality of computers are configured to further process a result of the processing of the non-overlapping subsets, wherein the further processing is performed over the data from the result as a whole, and wherein the first plurality of computers are configured to provide fail operational protection for the further processing.

4. The automation controller as recited in claim 1 wherein the first plurality of computers are configured to process data describing a plurality of objects surrounding the robotically-controlled mobile machine to generate a plurality of potential actions by the robotically-controlled mobile machine and the plurality of objects, wherein the first plurality of computers are configured to provide fail operational protection to generate the plurality of potential actions.

5. The automation controller as recited in claim 4 wherein respective computers of the first plurality of computers are configured to compute a plurality of trajectories from non-fully overlapping subsets of the plurality of potential actions, wherein the first plurality of computers are configured to provide fail degraded operation protection to compute the plurality of trajectories.

6. The automation controller as recited in claim 1 wherein the first plurality of computers are configured to evaluate a plurality of trajectories against a predetermined cost function to select the output trajectory, wherein the first plurality of computers are configured to check the output trajectory to ensure that the output trajectory has at least a specified minimum probability of avoiding a collision, and wherein the first plurality of computers are configured to provide fail operational protection to evaluate the plurality of trajectories to select the output trajectory and to ensure that the output trajectory has at least the specified minimum probability.

7. The automation controller as recited in claim 1 wherein the first plurality of computers are configured to detect a failure of a first one of the first plurality of computers and to continue operation of the robotically-controlled mobile machine in fail degraded mode based on the failure.

8. The automation controller as recited in claim 1 wherein the first plurality of computers are configured to detect a failure of at least two of the first plurality of computers and to bring the robotically-controlled mobile machine to a stop based on the failure.

9. The automation controller as recited in claim 1 wherein the one or more constraints include operating the robotically-controlled mobile machine at a reduced speed compared to fail operational mode.

10. The automation controller as recited in claim 1 wherein the one or more constraints include operating the robotically-controlled mobile machine while preventing one or more actions that the robotically-controlled mobile machine is permitted to perform when the first plurality of computers are operating.

11. A machine comprising:
a plurality of sensors; and
an automation controller coupled to the plurality of sensors, wherein the automation controller comprises:
a first plurality of computers configured to process sensor data from the plurality of sensors to generate an output trajectory to be followed by the machine, wherein the first plurality of computers are configured to provide fail degraded protection for a portion of the processing and fail operational protection for a remainder of the processing, wherein the fail degraded protection allows the machine to operate after a failure of one of the first plurality of computers with one or more constraints, wherein the one or more constraints are not applied to machine operation after a failure of one of the first plurality of computers with fail operational protection; and
a second plurality of computers coupled to the first plurality of computers and configured to control a plurality of actuators in the machine to cause the machine to follow the output trajectory, wherein the second plurality of computers implement a dual lockstep, doubly redundant mechanism to provide fail operational protection.

12. The machine as recited in claim 11, wherein respective computers of the first plurality of computers are configured to process sensor data from non-overlapping subsets of the plurality of sensors, and wherein the first plurality of computers are configured to provide fail degraded protection for processing of the sensor data from the subsets.

13. The machine as recited in claim 12 wherein the first plurality of computers are configured to further process a result of the processing of the non-overlapping subsets, wherein the further processing is performed over the sensor data as a whole, and wherein the first plurality of computers are configured to provide fail operational protection for the further processing.

14. The machine as recited in claim 13 wherein the first plurality of computers are configured to process a second result of the further processing to generate a plurality of potential actions by the machine and other objects indicated in the second result, wherein the first plurality of computers are configured to provide fail operational protection to generate the plurality of potential actions.

15. The machine as recited in claim 14 wherein the respective computers of the first plurality of computers are configured to compute a plurality of trajectories from non-fully overlapping subsets of the plurality of potential actions, wherein the first plurality of computers are configured to provide fail degraded operation protection to compute the plurality of trajectories.

16. The machine as recited in claim 15 wherein the first plurality of computers are configured to evaluate the plurality of trajectories to select the output trajectory, wherein the first plurality of computers are configured to check the output trajectory to ensure that the output trajectory has at least a specified minimum probability of avoiding a collision, and wherein the first plurality of computers are configured to provide fail operational protection to evaluate the plurality of trajectories to select the output trajectory and to ensure that the output trajectory has at least the specified minimum probability.

17. The machine as recited in claim 11 wherein the first plurality of computers are configured to detect a failure of a first one of the first plurality of computers and to continue operation of the machine in fail degraded mode based on the failure.

18. The machine as recited in claim 17 wherein the first plurality of computers are configured to detect a failure of at least two of the first plurality of computers and to bring the machine to a stop based on the failure.

19. A method comprising:
zonally processing sensor data from a plurality of sensors in respective computers of a first plurality of computers, providing fail degraded protection during the zonally processing;
centrally processing, by the first plurality of computers, data resulting from the zonally processing, providing fail operational protection during the centrally processing;
generating, by the first plurality of computers, a plurality of potential actions for a machine based on a plurality of objects surrounding the machine identified by the zonally processing and centrally processing;
generating a plurality of potential trajectories by the first plurality of computers based on the plurality of potential actions, providing fail degraded protection during the generating the plurality of potential trajectories; and
evaluating, by the first plurality of computers, the plurality of potential trajectories to select on output trajectory, providing fail operational protection during the evaluating.

20. The method as recited in claim 19 further comprising controlling a plurality of actuators in the machine to follow the output trajectory by a second plurality of computers, wherein the second plurality of computers provide dual lock step, double redundant fail operational protection.
